(19) United States
(12) Patent Application Publication
(10) Pub. No.: US 2024/0181804 A1
(43) Pub. Date: Jun. 6, 2024

(54) FASTENER ASSEMBLY WITH DECORATIVE COATED CAP

(71) Applicant: MACLEAN-FOGG COMPANY, Mundelein, IL (US)

(72) Inventors: Luke Michael ROBERTS, Madison Heights, MI (US); Mark Andrew RAVES, Mundelein, IL (US); Lee MAYERS, Mundelein, IL (US)

(73) Assignee: MACLEAN-FOGG COMPANY, Mundelein, IL (US)

(21) Appl. No.: 18/285,242

(22) PCT Filed: Mar. 31, 2022
(86) PCT No.: PCT/US2022/022811

§ 371 Date: Sep. 30, 2023

Related U.S. Application Data
(60) Provisional application No. 63/168,728, filed on Mar. 31, 2021.

(51) Int. Cl. B60B 7/06; C23C 28/00

(52) U.S. Cl. CPC B60B 7/06; C23C 28/345; B60B 2900/572

(57) ABSTRACT

A wheel fastener and method of forming a wheel fastener is provided. The wheel fastener has a fastener body comprising a threaded portion and an upper portion opposite the threaded portion. A load-bearing surface of the fastener body is shaped to cooperate with a fastener seat. A cap is decoupled from the fastener body and has a coating covering a cap base material to define a decorative appearance surface. The cap is crimped to the upper portion at a crimp area to retain the cap on the fastener body and define a wrenching surface. The cap does not cover the load-bearing surface. The coating of the cap comprises applying a nickel strike layer and a black chrome passivation layer to define a black appearance surface.

### CROSS-REFERENCE TO RELATED APPLICATIONS

This application claims the benefit of U.S. provisional application Ser. No. 63/168,728 filed Mar. 31, 2021, the disclosure of which is hereby incorporated in its entirety by reference herein.

### TECHNICAL FIELD

The present application relates to aesthetic wheel fasteners. In particular, the present application relates to wheel fasteners including caps.

### BACKGROUND

Aesthetics of a vehicle wheel is often a distinctive part of a vehicle. Therefore, the aesthetics is one concern for wheel fasteners, such as vehicle wheel nuts and wheel bolts. Wheel fasteners are also subjected to a wet and salty environment that is often encountered by the wheels of a vehicle and as a result susceptible to corrosion problems. However, corrosion on the visible surfaces of a wheel fastener greatly detracts from the aesthetic appearance of the wheel and the vehicle generally.

### SUMMARY

According to one embodiment, a wheel fastener is provided having a fastener body with a threaded portion and a wrenching surface shaped to receive torque from a tool. The fastener body has load-bearing surface shaped to cooperate with a fastener seat. A cap is decoupled from the fastener body and has a decorative coating covering a cap base material to define an appearance surface. The cap is secured to the fastener body to cover the wrenching surface without covering the load-bearing surface and the threaded portion.

In another embodiment, the decorative coating has a black chrome coating with a nickel strike layer and a black chrome passivation layer to define a black appearance surface.

In another embodiment, the black chrome passivation layer comprises a complex trivalent chromium oxide.

In another embodiment, there is a sealant layer over the black chrome passivation layer.

In another embodiment, the black chrome passivation layer has a thickness up to three microns.

In another embodiment, the decorative coating is a black physical vapor deposition (PVD) to define a black appearance surface.

In another embodiment, the decorative coating has a hard chrome layer between a nickel strike layer and the black PVD.

In another embodiment, the decorative coating of the fastener body has a flange extending radially outwardly from the wrenching surface, wherein a cap is crimped around the flange.

According to another embodiment, a method of forming a wheel fastener is provided. The method includes forming a fastener body having a wrenching surface shaped to cooperate with a tool and the fastener body having a threaded portion. A cap is preformed with a shape to cover an upper portion of the fastener body and cover the wrenching surface. The preformed cap is shaped to define a decorative appearance surface. The cap is crimped to secure the cap to the fastener body.

In another embodiment, the cap is preformed of stainless steel.

In another embodiment, the cap is preformed of carbon steel.

According to one embodiment, a wheel fastener is provided having a fastener body with a threaded portion and a wrenching surface shaped to receive torque from a tool. The fastener body has a load-bearing surface shaped to cooperate with a fastener seat. A cap is decoupled from the fastener body and has a black chrome coating covering a cap base material to define a black appearance surface. The cap is crimped to the fastener body to retain the cap on the fastener body and cover the wrenching surface.

In another embodiment, the black chrome coating has a nickel strike layer and a black chrome passivation layer to define the black appearance surface.

In another embodiment, the black chrome coating is free of anomalies along a crimp area so the nickel strike layer or a cap material is not visible.

### BRIEF DESCRIPTION OF THE DRAWINGS

FIG. 1 illustrates a side/cross-sectional view of a fastener assembly according to one embodiment.

FIG. 2 is an enlarged view of a coating of a fastener assembly of FIG. 1 according to one embodiment.

FIG. 3 shows a coated fastener according to another embodiment.

FIG. 4 depicts a method of forming a fastener assembly.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

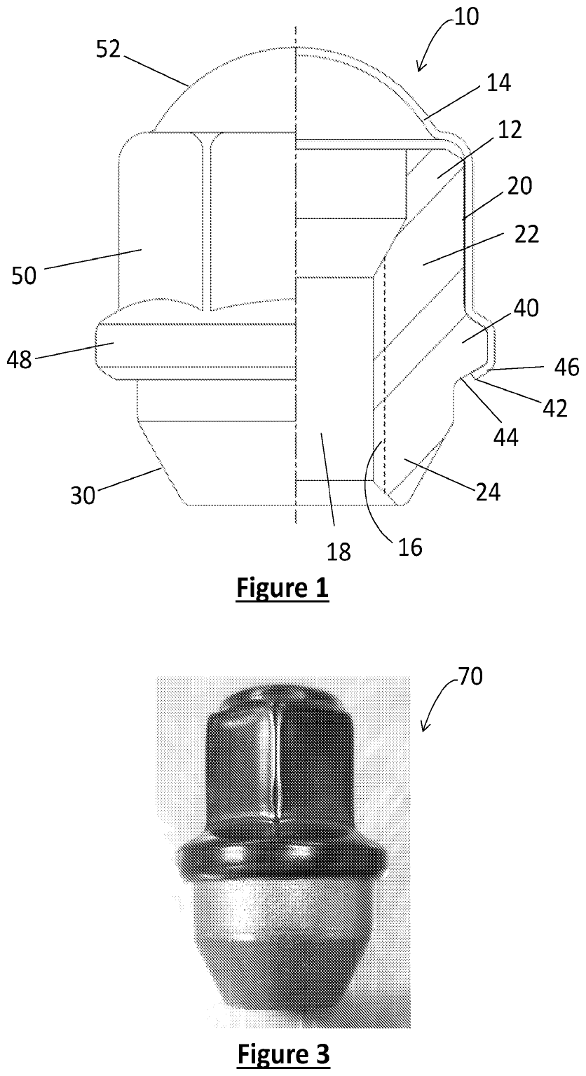

FIG. 1 illustrates a capped wheel fastener assembly 10 according to one embodiment. The assembly 10 includes a fastener body 12 and a decorative cap 14.

As illustrated in FIG. 1, the fastener body 12 may be a nut body having an internal threaded portion 16 formed along internal bore 18 extending axially through the fastener body 12.

The fastener body 12 has a torque-bearing surface, or wrenching surface 20 formed as an out-of-round surface at an upper portion 22. As illustrated, the torque-bearing surface 20 may be a hexagonal-shaped surface to be engaged by a standard hexagonal tool. Other suitable torque-bearing surfaces such as a different polygonal shape with a different number of wrenching surfaces or, any suitable shape, configuration or standard of tool wrenching surface may be used. In one example, the fastener may have a three-point torque-bearing surface such as U.S. patent application Ser. No. 15/487,805 by Wilson et al., or a hybrid three-point torque-bearing surface, such as in U.S. patent application Ser. No. 15/872,386 by Tomaszewski et al., the disclosures of which are hereby incorporated by reference herein. Other suitable torque-bearing surfaces may also be formed on the fastener body 12. The fastener assembly 10 may also have an improved wrenching design and torque bearing surface according to U.S. Pat. No. 8,491,247 by Wilson, the disclosure of which is hereby incorporated by reference herein. The cap 14 may have a decorative wrenching surface that matches the size and styling of the exiting wheel fasteners, but the cap will rotate separately to the fastener and applying torque to the wrenching surface on the cap will not remove the fastener or may not affect tension in the joint, such as in U.S. Patent Application No. 63/315,434 by Deeds et al., or U.S. Patent Application No. 63/296,422 by Raves et al., the disclosures of which are hereby incorporated by reference herein.

The lower portion 24 of the nut body 16 has a load-bearing surface 30. As illustrated, the load-bearing surface 30 has a frustoconical shape; however, the load-bearing surface 30 may be spherical or other suitable shape for seating in a wheel rim aperture to fasten the wheel rim to a vehicle wheel stud. In another embodiment, the lower portion 24 of the fastener body 12 may also be a bolt body having an external threaded portion formed on a protrusion extending below the load bearing surface 30.

The fastener body 12 may be formed of carbon steel in a conventional manner. The fastener body 12 may be coated to prevent oxidation and corrosion. For example, the coating may be composed of zinc and aluminum and be chromium-free. The coating may be applied over the entire fastener body 12.

A flange 40 is formed between the hex-shaped surface 20 and the load-bearing surface 30. The flange 40 defines an outer cylinder that extends radially outward from the torque bearing surface 20 and the load bearing surface 30. Below the flange 40, and above the load-bearing surface 30, there is an undercut 44.

The cap 14 is placed over the upper portion 22 and covers torque-bearing surface 20 and flange 40. A lower edge 42 of the cap 14 and is crimped inward along the undercut 44 to form an inward crimp segment 46. Crimping the lower end of the cap 14 around the outer flange 40 retains the cap 14 onto the fastener body 12 so that the cap 14 does not move axially along the fastener body 12 in use.

The cap 14 has wall segments to align with the torque-bearing surface 20 and provide the outer surface 50. The outer surface 50 may be shaped as a torque-bearing surface or wrenching surface. The outer surface 50 may also have any decorative shape. The upper portion 22 may also have a stem that does not have a torque-bearing surface and the cap 14 may have decorative wrenching surfaces where applying torque to the decorative wrenching surface on the cap and will not remove the fastener or may not affect tension in the joint. The cap 14 may also freely-spin on the fastener body 12 when torque is applied to the decorative wrenching surfaces.

A cylindrical surface 48 extends over the flange 40. After the fastener body 12 is placed into the cap 14, a lower edge of the cylindrical surface 48 is crimped inward to form the crimp segment 46. The crimp segment 46 is crimped into engagement with the undercut 44 on the fastener body 12 and assures that cap 14 will not be dislodged from the fastener body even under extreme or repeated wrenching, or other environmental conditions.

The fastener body 12 may be placed into the cap 14 with an interference fit, or a slip fit. The crimp then also blocks entry of moisture between the cap 14 on the fastener body 12 along the upper portion 22.

The cap 14 also has an end segment 52 defining the distal end of the fastener assembly 10. The end segment 52 may be domed, as shown, of point, flat or another suitable shape for decorative purposes.

The cap 14 also provides a decorative appearance to the fastener assembly 10. Since the cap 14 is decoupled from the fastener body 12, the cap 14 may be coated to provide a desired aesthetic appearance surface different than the fastener body 12. For example, the cap 14 may be coated to have a black chrome appearance surface. However, other colors and/or coating materials may be used to provide different aesthetic appearances.

Wheel fasteners must have a repeatable coefficient of friction in order to assure that a given installation torque will equal the desired clamp load. Wheel fasteners are also subjected to a corrosive environment. For these reasons, decoupling the cap 14 from the fastener body 12 allows the cap 14 to be coated to provide corrosion resistance, as well as aesthetic appearance, while leaving the fastener body 12 free of coatings, such as chrome, that negativity impacts friction control of the threaded surfaces and load-bearing surfaces.

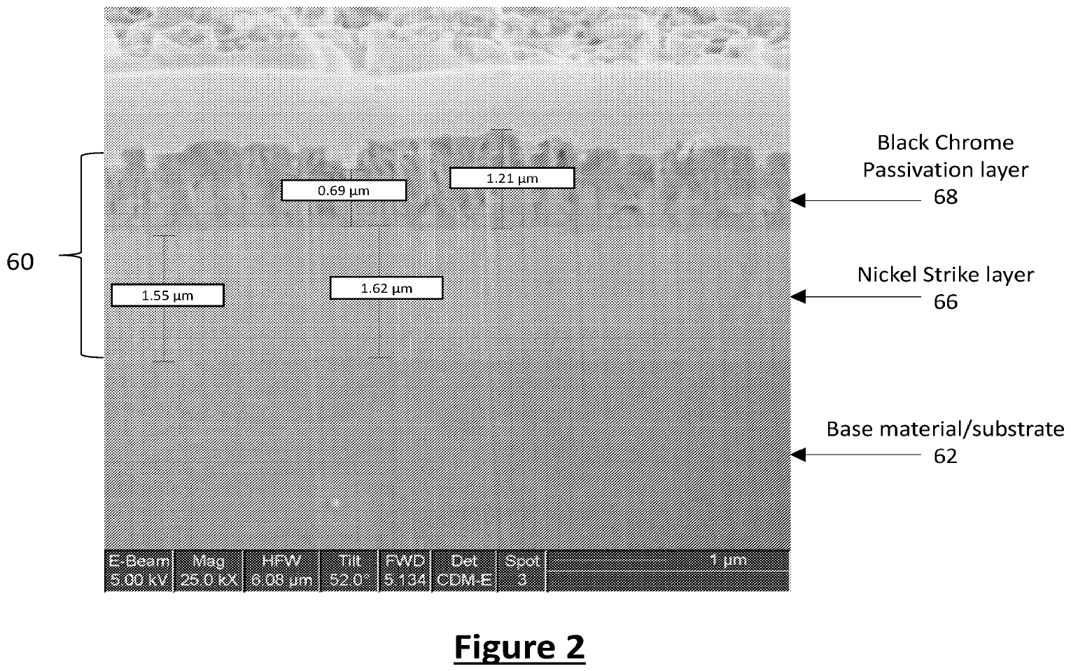

In one embodiment, the cap 12 has a black chrome coating 60 covering a cap base material 62. The black chrome coating 60 is formed of a nickel strike layer 66 and a black chrome passivation layer 68 to define the black appearance surface on the cap 14. FIG. 2 shows a 25,000 times magnification micrograph of the black chrome passivation layer 68 superficially reacting with nickel strike layer 66.

Traditional bright chrome on nickel plating has a significant thickness of 25-30 microns that is necessary for brightness and corrosion protection but will crack if used in applications requiring bending or crimping of the cap 14.

The coating 60 illustrated in FIG. 2 has a nickel strike layer 66 with a minimal thickness for allowing the chromate to passivate so reaction only takes place with surface of the nickel layer 66, and not with the base material 62. Therefore, the nickel strike layer 66 only thinly covers the base material 62. The base material layer 62 may be stainless steel, carbon steel, or another suitable base layer.

The black chrome passivation layer 68 reacts superficially with the nickel. The black chrome passivation is a treatment applied onto the nickel strike with a final product of complex trivalent chromium oxides. In one embodiment, the black chrome passivation layer may be formed in a plating bath having hexavalent chrome and through the process converts to a trivalent chrome that cannot revert to hexavalent chrome. The chrome passivation layer 68 meets environmental requirements while minute amounts of homogeneous materials may be tolerated. The final appearance is deep black but under some conditions there are areas displaying iridescent, brassy, or a dull black appearance. Chrome passivation is typically referred to as chromate in the industry. The nickel (Ni) is deposited with electroplating on the base material 62. The black chrome passivation layer 68 may be electroplated on the nickel strike layer 66.

The black chrome coating 60 may have a smooth and flat surface and no nickel or base material is visible. The black chrome coating 60 has a thickness that prevents any visual anomalies such as cracking, peeling or flaking during the crimping of the cap or wrenching of the fastener during assembly. Wear marks due to the crimp tool may be acceptable, but the base layer 62 and/or the nickel strike layer 66 are not visible below the black chrome passivation layer 68. The black chrome passivation layer 68 is not removed and maintains adhesion during crimping and repeated wrenching. Maintaining a controlled thickness of the coating ensure there is no cracking, peeling or flaking on any of the appearance surfaces. There shall be no nickel or stainless steel visible at the undercut surface 44. Black chrome provides a uniform black color.

In one embodiment, the nickel strike layer 66 may have a thickness in the range of 0.1 microns to 3.5 microns. In another embodiment, the nickel strike layer 66 may have a thickness of less than 0.1 microns. In another embodiment, the nickel strike layer 66 may have a thickness up to 11 microns.

The thickness of the black chrome passivation layer 68 is one factor that affects appearance. In one embodiment, the thickness of the black chrome passivation layer 68 may be in the range of 0.1 microns to 2.1 microns. In another embodiment, the black chrome passivation layer 68 may have a thickness up to 3 microns. As shown in FIG. 2, the black chrome passivation layer 68 may have variations along the surface and the thickness may be difficult to measure. Therefore, the thickness of the black chrome passivation layer 68 may not be specified or may be measured as an average or mean-value. Several factors may also affect color including bath temperature, bath contamination and other manufacturing parameters.

The nickel strike layer 66 is applied in order to condition the base material 62 of the cap 14 for acceptance of the black chrome passivation layer 68. The cap 14 may be formed of a base material being a stainless-steel sheet. In another embodiment, the cap 14 may be formed of a base material being carbon steel.

After the black chrome treatment, a sealer such as an oil, wax or clear lacquer may be applied onto the black chrome passivation layer 68 to improve its uniformity, reflectivity and to increase its depth of black color. Some sealers also improve the wearability of the black chrome plating system.

The plating thickness of the nickel strike layer 66 and black chrome passivation layer 68 may be measured by cross section analysis using a light or scanning electron microscope (SEM). Alternatively, focused ion beam (FIB) may be used to etch the specimen and together with SEM and BSE (backscatter electron) analysis obtains plating thickness. Thickness measurements acquired via these methods shall be referred hereinafter as “true layer thickness” measurements, but are destructive and therefore not feasible for production.

Nondestructive thickness (NDT) measurements were developed using X-ray fluorescence (XRF) to determine plating thickness once a correlation was established between XRF and true layer thickness. While XRF is reasonably accurate for normal steels and plastics, XRF is not typically accurate with steels having Nickel content, including stainless steels. According to one embodiment of the application, a correlation was developed to relate XRF readings of chrome plating on stainless steel parts and back-scatter electron measurements, thus enabling XRF testing to be quantifiable for plating thickness testing on chrome plated stainless steel. This is particularly useful in the manufacture of black color capped wheel fasteners, and in particular fasteners with a stainless-steel cap. The stainless-steel capped wheel fastener solved the problem of repeatable wheel fastening function without corrosion and with high durability. However, stainless steel only has a natural bright finish. By adding a decorative coating to the cap, such as a black chrome coating, the fastening function is preserved, while providing a decorative appearance to the cap, such as a black color. However, in-process measurement of the chrome coating thickness was not possible, due to XRF's issues with nickel. In-process checks are needed to assure part quality. The issue of correlating XRF to thickness needed to be solved in order for part process capability to be measure and assured. The thickness of the black chrome passivation layer and the thickness of the nickel strike layer both must be measured and therefore a correlation factor was developed using XRF to measure the thicknesses and ensure threshold thicknesses were maintained.

FIG. 3 shows a fastener assembly 70 having a decorative coating on the cap 14 according to another embodiment. The fastener assembly 70, as pictured, has a black physical vapor deposition (PVD) layer. Physical Vapor Deposition (PVD) produces a hard coating that is metal-based by generation of partially ionized metal vapor, its reaction with certain gases and by forming a thin film with a specified composition on the base material 62 of the cap 14. The PVD coating process is performed under a high vacuum. The PVD process may be used to form coatings made of nitrides, carbides and carbonitrides of Ti, Cr, Zr and alloys like AlCr, AlTi, TiSi, for example.

In one embodiment, the PVD layer has a thickness in the range of 0.2 to 15 microns. In another embodiment, the PVD layer has a thickness in the range of 0.2 to 5 microns. In another embodiment, the PVD layer has a thickness in the range of 0.2 to 2 microns. The PVD coating may be applied over the nickel strike layer 66. In addition, a hard chrome/bright chrome layer may be formed between the nickel strike layer and the black PVD layer.

In another embodiment, the fastener assembly may have a black oxide decorative coating on the cap 14. Applying the black oxide coating includes a process of forming a black iron oxide on the surface of ferrous metals. The black oxide coating is produced by a chemical reaction between the iron on the surface of the ferrous metal and the oxidizing salts present in the black oxide solution. The chemical reaction forms a black iron oxide, magnetite (Fe₃O₄), on the surface of the base material 62 of the cap 14. A post treatment may be applied to the black oxide coating to increase the corrosion resistance. The black oxide layer is extremely thin and has a thickness 10 millionths of an inch.

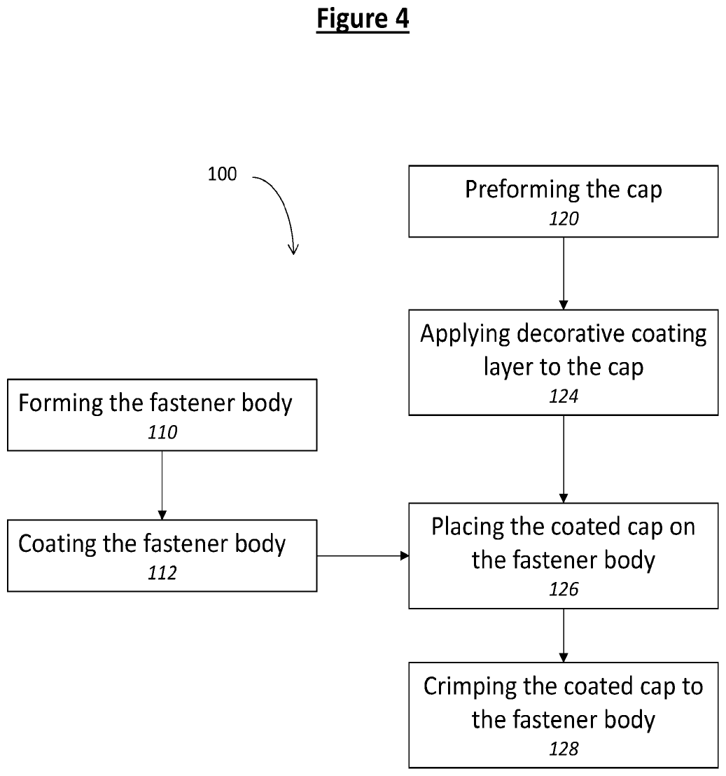

FIG. 4 illustrates a method of forming the fastener assembly 10. Decoupling the cap 14 from the fastener body 12 allows the cap 14 to be coated to provide a desired aesthetic appearance without coating the load-bearing surface or the threaded portion. The decoupled cap also allows for the coating to have a controlled thickness for durability and corrosion resistance even after the cap 14 is press-fit and/or crimped onto the fastener. FIG. 4 illustrates a method 100 of forming the fastener assembly 10.

At step 110, the fastener body 12 is formed according to standard processes or suitable processes known to a person of ordinary skill in the art. At step 112, the fastener body 12 may be coated with a coating that provides corrosion resistance and the correct coefficient of friction for the threaded surfaces. At step 112, the entire fastener body 12 without the cap 14 may be coated.

At step 120, the cap 14 is formed. Since the cap 14 is decoupled from the fastener body 12, the cap 14 is preformed to correspond to the fastener body 12. The cap 14 may be preformed of the base material in stainless steel or carbon steel. The cap 14 may be formed according to standard processes or suitable processes known to a person of ordinary skill in the art.

At step 124, the decorative coating layer is applied to the cap 14. In the example of a black chrome decorative coating, the nickel strike layer 66 is applied to the preformed cap with electroplating. Then the black chrome passivation layer 68 is applied to the preformed cap over the nickel strike layer 66. In one embodiment, the black chrome passivation layer 68 is applied with electroplating. In other embodiments, the decorative coating may be black physical vapor deposition (PVD) or black oxide layer. In at least one embodiment, a hard chrome/bright chrome layer may be applied between the nickel strike layer 66 and the black PVD.

At step 126, the preformed cap with chrome coating is placed on the fastener body 12. The fastener body 12 may engage the preformed cap with an interference fit, such as a press fit. Finally, at step 128, the cap 14 is crimped to the fastener body 12. The cap 14 is secured to the fastener body 12 without welding or adhesive or additional components.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A wheel fastener comprising:
a fastener body comprising:
a threaded portion;
a wrenching surface shaped to receive torque from a tool;
a load-bearing surface shaped to cooperate with a fastener seat; and
a cap decoupled from the fastener body and having a black coating covering a cap base material to define a decorative black appearance surface,
wherein the cap is secured to the fastener body at a crimp area thereby covering the wrenching surface without covering the load-bearing surface and the threaded portion.

2. The wheel fastener of claim 1, wherein the black coating has a nickel strike layer and a black chrome passivation layer to define the decorative black appearance surface.

3. The wheel fastener of claim 2, wherein the black chrome passivation layer comprises a complex trivalent chromium oxide.

4. The wheel fastener of claim 2, further comprising a sealant layer over the black chrome passivation layer.

5. The wheel fastener of claim 2, wherein the black chrome passivation layer has a thickness less than 3 microns.

6. The wheel fastener of claim 5, wherein the black chrome passivation layer has a thickness in the range of 0.1 to 2.1 microns.

7. The wheel fastener of claim 2, wherein the nickel strike layer has a thickness less than 11 microns.

8. The wheel fastener of claim 2, wherein the black coating comprises a black physical vapor deposition (PVD) to define the decorative black appearance surface.

9. The wheel fastener of claim 8, wherein the black coating further comprises a hard chrome layer between the nickel strike layer and the black PVD.

10. The wheel fastener of claim 1, wherein a base material of the cap comprises stainless steel.

11. The wheel fastener of claim 1, wherein a base material of the cap comprises carbon steel.

12. The wheel fastener of claim 1, wherein the cap has a crimp area to retain the cap on the fastener body.

13. The wheel fastener of claim 12, wherein the fastener body has a flange extending radially outwardly from the wrenching surface, wherein the crimp area is positioned adjacent the flange.

14. A method of forming a wheel fastener, the method comprising:
forming a fastener body having an upper portion and a threaded portion opposite the upper portion;
preforming a cap to cover the upper portion of the fastener body;
coating the cap to define a decorative appearance surface;
crimping the cap to the upper portion of the fastener body to secure the cap to the fastener body.

15. The method of claim 14, wherein coating the cap comprises applying a nickel strike layer and a black chrome passivation layer to define the decorative appearance surface being a black appearance surface.

16. The method of claim 15, further comprising measuring the black chrome passivation layer and nickel strike layer to ensure a thickness of the coating is less than a threshold thickness.

17. The method of claim 14, further comprising preforming the cap of stainless steel.

18. The method of claim 14, wherein coating the cap comprises applying a black physical vapor deposition (PVD) to define the decorative appearance surface being a black appearance surface.

19. A wheel fastener comprising:
a fastener body comprising a threaded portion and an upper portion opposite the threaded portion and a load-bearing surface shaped to cooperate with a fastener seat; and
a cap decoupled from the fastener body and having a decorative coating covering a cap base material to define a black appearance surface,
wherein the cap is crimped to the upper portion of the fastener body at a crimp area to retain the cap on the fastener body and define a wrenching surface on the cap without covering the load-bearing surface and the threaded portion on the fastener body.

20. The wheel fastener of claim 19, wherein the decorative coating comprises a black chrome coating having a nickel strike layer and a black chrome passivation layer to define a black appearance surface, wherein the black chrome coating is free of anomalies along a crimp area so the nickel strike layer or a cap material is not visible
